(19) United States
(12) Patent Application Publication
(10) Pub. No.: US 2015/0090190 A1
(43) Pub. Date: Apr. 2, 2015

(54) DOG BED

(71) Applicant: Worldwise, Inc., San Rafael, CA (US)

(72) Inventor: Aimee Diskin, Napa, CA (US)

(73) Assignee: Worldwise, Inc., San Rafael, CA (US)

(21) Appl. No.: 14/043,618

(22) Filed: Oct. 1, 2013

(51) Int. Cl. A01K 1/035; A01K 1/03

(52) U.S. Cl. CPC A01K 1/0353; A01K 1/033
USPC 119/482

(57) ABSTRACT

A dog bed for facilitating the lounging and security of a dog of a known size. A resilient compressible fill material is contained within a shell material which defines the size and shape of the dog bed. A pouch is configured onto the shell material, the pouch having a size and opening matched to the known size of the dog such that the pouch and opening facilitate the dog being able to enter and reside within the pouch.

### TECHNICAL FIELD OF INVENTION

The present invention is directed to a dog bed which not only provides a place where a dog can sleep and lounge but also provides an element of security which many dogs require to thrive.

### BACKGROUND OF THE INVENTION

There are many dog beds available to consumers having a variety of sizes and shapes. Dog beds are oftentimes chosen to match the decor of their surroundings with little regard being given to the needs of the pet intending to use it. In addition, virtually all dog beds are designed to provide adequate support to enable a dog to lounge or sleep on their support surface. Stuffing is packed within an outer shell for this purpose without addressing any other needs that a dog might have.

It has been found that dogs, like cats and other domesticated animals, oftentimes seek the security of nesting in a familiar place. Dogs will oftentimes attempt to hide in their own blankets and also take comfort that, in doing so, they are surrounded by smells and sounds that they are familiar with. Although a blanket can be placed upon a typical dog bed, as it simply is draped over the top of the bed, it provides for no secure nesting area.

Thus an object of the present invention to provide a dog bed which not only creates the appropriate support surface for lounging and sleeping, but also addresses a dog's need to nest in a familiar hideout.

It is a further object of the present invention to provide a dog bed which can also store clothing objects of a household member or similar objects to provide familiar smells and appropriate comfort.

These and further objects may be more readily appreciated when considering the following disclosure and appended claims.

### SUMMARY OF THE INVENTION

A dog bed for facilitating lounging and security of a dog of a known size, said dog bed comprising a resilient, compressible fill material and a shell material containing said resilient compressible fill material and for defining the size and shape of the dog bed and a pouch configured onto said shell material, said pouch having a size and opening matched to the known size of the dog using the dog bed, such that said pouch and opening are sized to facilitate said dog being able to enter and reside within said pouch.

### BRIEF DESCRIPTION OF THE DRAWINGS

FIG. 1 is a perspective view of the dog bed of the present invention.

FIG. 2 is a cross-sectional view of the dog bed of the present invention taken along line 2-2 of FIG. 1.

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined more important features of the invention in the summary above and in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important therefore, that claims be regarded as including such equivalent constructions insofar as they do not depart from the spirit and scope of the present invention.

Certain terminology and the derivations thereof may be used in the following description for convenience and reference only, and will not be limiting. For example, words such as “upward,” “downward,” “left,” and “right” refer to directions in the drawings to which reference is made unless otherwise stated. Similar words such as “inward” and “outward” refer to directions toward and away from, respectively, the geometric center of a device or area and designated parts thereof. Reference in the singular tense include the plural and vice versa, unless otherwise noted.

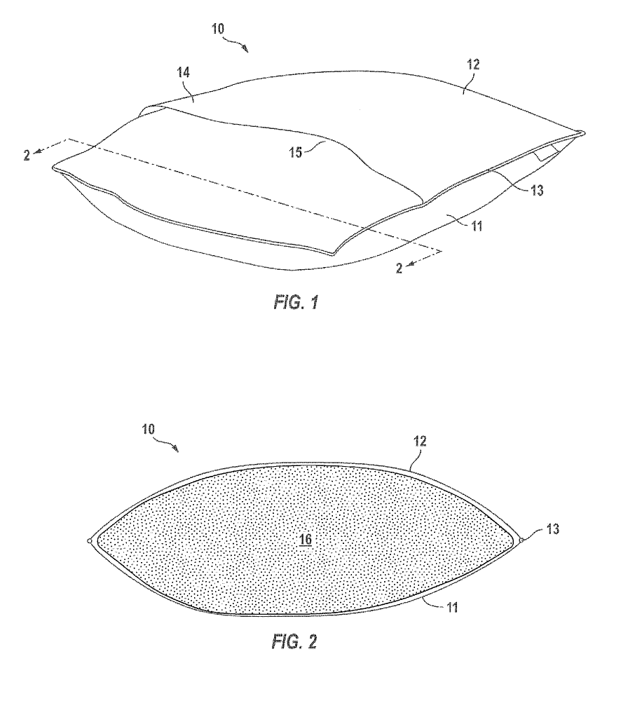

Turning to FIG. 1, dog bed 10 is disclosed for facilitating lounging and security of a dog of a known size. In selecting the appropriate size of dog bed 10 one would first make note of the size of the family pet or if one is in the market for becoming a pet owner, the size that the dog will eventually mature into. This will dictate not only the footprint of dog bed 10 but also the size of the formed pouch 20, the purpose of which will be more readily appreciated in the discussion which follows.

Dog bed 10 comprises a resilient, compressible fill material 16 (FIG. 2) which is surrounded by a shell material composed of upper and lower covers 11 and 12, respectively. Pouch 20 is configured onto the shell material, the pouch 20 having a size and opening 15 matched to the known size of the dog using dog bed 10 such that pouch 20 and opening 15 are sized to facilitate the dog being able to enter and reside within the pouch.

Ideally, upper and lower covers 12 and 13, embracing fill material 16 in establishing the shape and size of dog bed 10 are connected by seam 13 as shown. Fabric sheet 14 is joined to upper and lower covers 12 and 11 along seam 13 to form pouch 20 and to define its shape and volume. Fabric sheet 14 is again provided with opening 15 to establish a pouch volume, said opening sized to receive a dog of a known size. Ideally, the pouch is sized to facilitate the ability of the dog to enter the pouch and be completely enclosed by it.

Although the purpose for pouch 20 is primarily to provide a secure hideout for a dog using dog bed 10, pouch 20 can also be used to receive clothing objects of the dog's owner which the dog would associate with its owner and be comforted by the proximity of such objects. As such, pouch 20 performs a dual purpose unappreciated by commonly available pet beds of the prior art.

The above disclosure is sufficient to enable one of ordinary skill in the art to practice the invention, and provides the best mode of practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable without departing from the true spirit and scope of the invention. Such changes might involve alternative materials, components, structural arrangements, sizes, shapes, forms, functions, operational features or the like. Therefore, the above description and illustration should not be considered as limiting the scope of the invention, which is defined by the appended claims.

What is claimed is:

1. A dog bed for facilitating lounging and security of a dog of a known size, said dog bed comprising a resilient, compressible fill material and a shell material containing said resilient compressible fill material and for defining the size and shape of the dog bed, a pouch configured onto said shell material, said pouch having a size and opening matched to the known size of the dog using the dog bed, such that said pouch and opening are sized to facilitate said dog being able to enter and reside within said pouch.

2. A dog bed for facilitating lounging in security of a dog of a known size, said dog bed comprising a resilient compressible fill material, upper and lower covers, such upper and lower covers being joined by a seam to define the shape of said dog bed, a fabric sheet joined to said upper or lower covers along said seam to form a pouch and to define its shape and volume, said fabric sheet having an opening wherein said volume and opening are sized to receive said dog of known size.

3. The dog bed of claim 1 wherein said pouch is sized to facilitate the ability of said dog to enter said pouch and be completely enclosed thereby.

4. The dog bed of claim 2 wherein said pouch is sized to facilitate the ability of said dog to enter said pouch and to be completely enclosed thereby.
